(19) United States
(12) Patent Application Publication
(10) Pub. No.: US 2012/0284137 A1
(43) Pub. Date: Nov. 8, 2012

(54) Method and System for Reducing Short-Term Participation in Auctions

(76) Inventors: Mike Beckham, Norman, OK (US); Shaun Tilford, Edmond, OK (US); Michael Morrison, Edmond, OK (US)

(21) Appl. No.: 13/164,566

(22) Filed: Jun. 20, 2011

Related U.S. Application Data
(60) Provisional application No. 61/483,506, filed on May 6, 2011.

(51) Int. Cl. G06Q 30/08

(52) U.S. Cl. 705/26.3

(57) ABSTRACT

An online auction system comprises a host system. The host system comprises at least one processor capable of executing processor executable code, at least one non-transient memory capable of communicating with the at least one processor and storing processor executable code comprising a first rank associated with a first user and a second rank associated with a second user. The processor executable code when executed by the at least one processor, causes the at least one processor to access the first rank and second rank, schedule a first auction having a first rank range and a second auction having a second rank range, and present the first auction having the first rank range to the first user and the second auction having the second rank range to the second user. The first rank of the first user falls within the first rank range and the second rank of the second user falls within the second rank range. A method for scheduling online auctions comprises accessing, by a host system comprising at least one processor, processor executable code stored on a non-transient memory. The processor executable code comprises a first rank associated with a first user and a second rank associated with a second user. The host system schedules, by the at least one processor, a first auction having a first rank range and a second auction having a second rank range. The host system presents the first auction having the first rank range to the first user and the second auction having the second rank range to the second user. The first rank of the first user is identified by the first rank range and the second rank of the second user is identified by the second rank range.

### CROSS-REFERENCE TO RELATED APPLICATIONS

This application claims the benefit under 35 U.S.C. 119(e) of U.S. Provisional Application Ser. No. 61/483,506, filed May 6, 2011, the contents of which are hereby expressly incorporated herein by reference in their entirety.

### BACKGROUND

The inventive concept disclosed herein generally relates to online auctions, and more particularly, but not by way of limitation, to a method and system for reducing short-term participation in certain auctions, such as a penny auction.

Online auctions have existed in various forms since as early as the late 1970's, long before the advent of the World Wide Web, when primitive auctions were conducted on early Internet Bulletin Board Services. Modern online auctions began in 1995 with the launch of AuctionWeb, which would later become eBay.

The penny auction industry was born in September 2005, when Telebid launched in Germany. Penny auctions are distinct from traditional online auctions in that bidders pay a participation fee for each bid placed. Telebid users were initially required to phone-in bids, but the site was later modified to allow users to place bids through a web browser. In 2008, Telebid changed its name to Swoopo and expanded to several other countries, including the U.S. and U.K. Many other penny auctions were soon launched in the U.S. and elsewhere, including QuiBids, BigDeal, BidCactus, BidRivals, and Beezid.

Several penny auction sites have recently implemented a feature which allows users to purchase items directly, or at a discount partially or completely reflecting the cost of any bids placed on the item by that particular user either during or after an auction.

One of the biggest challenges online penny auction companies face is retaining users. Even if a penny auction company is able to keep user costs per acquisition low, and has a high conversion rate, if new users do not become long-term users, the penny auction company will not thrive. Penny auctions are skill-based, which makes the auctions very competitive. If inexperienced users are pitted against skilled users who have been participating in penny auctions for months, the inexperienced users will win few auctions and are very likely to become frustrated and stop visiting the site. This is most likely why several penny auction websites have recently failed; these sites were dominated by very aggressive and skilled users who would win auctions in which the new and inexperienced users were participating.

To that end, a need exists in the prior art to provide an online auction system, such as a penny auction system, where participation is reduced in the short-term to increase participation with respect to the auctions provided by the site in the long-term. This can be accomplished by not pitting new and inexperienced users against skilled users. It is to such an online auction system and method that the present disclosure is directed.

### SUMMARY

In one aspect, the inventive concept disclosed herein is directed to an online auction system. The system has a host system comprising at least one processor capable of executing processor executable code and at least one non-transient memory capable of communicating with the at least one processor and storing processor executable code. The code stored in the memory comprises a first rank associated with a first user and a second rank associated with a second user. The processor executable code, when executed by the at least one processor, causes the at least one processor to access the first rank and second rank, schedule a first auction having a first rank range and a second auction having a second rank range, and present the first auction having the first rank range to the first user and the second auction having the second rank range to the second user. The first rank of the first user falls within the first rank range and the second rank of the second user falls within the second rank range.

In another aspect, the inventive concept disclosed herein is directed to a method for scheduling online auctions. The method comprises (a) accessing, by a host system comprising at least one processor, processor executable code stored on a non-transient memory, the processor executable code comprising a first rank associated with a first user and a second rank associated with a second user; (b) scheduling, by the at least one processor, a first auction having a first rank range and a second auction having a second rank range; and (c) presenting the first auction having the first rank range to the first user and the second auction having the second rank range to the second user. The first rank of the first user is identified by the first rank range and the second rank of the second user is identified by the second rank range.

In another aspect, the inventive concept disclosed herein is directed to an online auction system. The system has a host system comprising at least one processor capable of executing processor executable code and at least one non-transient memory capable of communicating with the at least one processor and storing processor executable code comprising a first rank associated with a first user and a second rank associated with a second user. The processor executable code when executed by the at least one processor, causes the at least one processor to: (a) access the first rank and the second rank; (b) schedule a first auction having a first rank range; and (c) present the first auction having the first rank range to the first user but not to the second user. The first rank of the first user is identified by the first rank range and the second rank of the second user is not identified by the first rank range.

In yet another aspect, the inventive concept disclosed herein is directed to an online auction system. The system has a host system comprising at least one processor capable of executing processor executable code and at least one non-transient memory capable of communicating with the at least one processor and storing processor executable code comprising a first rank associated with a first user and a second rank associated with a second user. The processor executable code, when executed by the at least one processor, causes the at least one processor to execute auction presentation logic to: (a) receive information indicative of a first item to be auctioned, including a rank range; (b) analyze a first user profile of a first user logged into the host system with the rank range; (c) analyze a second user profile of a second user logged into the host system with the rank range; (d) generate one or more first auction presentation pages for the first user including the first item based upon the analysis of the first user profile; and (e) generate one or more second auction presentation page for the second user not including the first item based upon the analysis of the second user profile.

In yet another aspect, the inventive concept disclosed herein is directed to a method, comprising the steps of (a) receiving, by a host system configured to provide an auction, a logon command from a terminal for a particular user having a rank; and (b) serving one or more auction presentation pages to the terminal including ongoing or upcoming auctions that match the rank of the user.

In yet another aspect, the inventive concept disclosed herein is directed to a method, comprising the steps of: (a) receiving a logon command by a host system from a terminal for a user having a rank, the host system configured to provide multiple simultaneous auctions including first auctions matching the rank of the user and second auctions not matching the rank of the user; and (b) serving one or more auction presentation pages to the terminal with the first auctions and without the second auctions.

In yet another aspect, the inventive concept disclosed herein is directed to a method, comprising the steps of: (a) crediting an account of a user with a first bid and a second bid; (b) receiving a logon command by a host system from a terminal for a user having a rank, the host system configured to provide multiple simultaneous auctions including first auctions matching the rank of the user and second auctions not matching the rank of the user; (c) serving one or more auction presentation pages to the terminal with the first auctions and without the second auctions; (d) receiving the first bid from the user for a first item of one of the first auctions; and (e) increasing a price of the first item by a predetermined amount responsive to receiving the first bid.

In yet another aspect, the inventive concept disclosed herein is directed to a method, comprising the steps of: (a) crediting an account of a user with a first bid; (b) logging the user into the account by a host system, the account having a rank of the user, the host system configured to provide multiple simultaneous auctions including first auctions matching the rank of the user and second auctions not matching the rank of the user; (c) serving one or more auction presentation pages to the user with the first auctions and without the second auctions, while the user is logged on; (d) receiving the first bid from the user for a first item before a first ending time of one of the first auctions; (e) increasing a price of the first item by a predetermined amount responsive to receiving the first bid; and (f) extending the first ending time of the one of the first auctions by an amount of time defining a second ending time of the one of the first auctions.

In yet another aspect, the inventive concept disclosed herein is directed to an online auction system comprising a host system comprising at least one processor capable of executing processor executable code, and at least one non-transient memory capable of communicating with the at least one processor and storing processor executable code. The processor executable code when executed by the at least one processor, causes the at least one processor to: (a) credit an account of a user with a first bid; (b) log the user into the account by a host system, the account having a rank of the user, the host system configured to provide multiple simultaneous auctions including first auctions matching the rank of the user and second auctions not matching the rank of the user; (c) serve one or more auction presentation pages to the user with the first auctions and without the second auctions, while the user is logged on; (d) receive the first bid from the user for a first item before a first ending time of one of the first auctions; (e) change a price of the first item by a predetermined amount responsive to receiving the first bid; and (f) extend the first ending time of the one of the first auctions by an amount of time defining a second ending time of the one of the first auctions.

In yet another aspect, the inventive concept disclosed herein is directed to an online auction system comprising a host system. The host system has at least one processor capable of executing processor executable code and at least one non-transient memory capable of communicating with the at least one processor and storing processor executable code. The processor executable code comprises a first rank associated with a first user and a second rank associated with a second user. The processor executable code when executed by the at least one processor, causes the at least one processor to execute auction presentation logic to: (a) receive information indicative of two or more first items to be auctioned; (b) analyze a first user profile of a first user logged into the host system with a first rank range; (c) analyze a second user profile of a second user logged into the host system with a second rank range; (d) generate one or more first auction presentation pages for the first user including at least one of the two or more first items based upon the analysis of the first user profile; and (e) generate one or more second auction presentation page for the second user including at least one of the two or more first items based upon the analysis of the second user profile.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a schematic diagram of an embodiment of an online auction system according to the instant disclosure.

FIG. 2 is a block diagram of an embodiment of a memory according to the instant disclosure.

FIG. 3 is a screenshot of an exemplary embodiment of an auction presentation page according to the instant disclosure.

FIG. 4 is a logic flow diagram of an exemplary embodiment of user ranking logic according to the instant disclosure.

FIG. 5 is a logic flow diagram of an exemplary embodiment of auction scheduling logic according to the instant disclosure.

FIG. 6 is a diagram of an exemplary method of presenting auctions to users according to the instant disclosure.

FIG. 7 is a screenshot of an exemplary embodiment of a user registration page according to the instant disclosure.

FIG. 8 is a screenshot of an exemplary embodiment of an auction scheduling page according to the instant disclosure.

### DETAILED DESCRIPTION

Before explaining at least one embodiment of the inventive concept disclosed herein in detail, it is to be understood that the inventive concept is not limited in its application to the details of construction and the arrangement of the components or steps or methodologies set forth in the following description or illustrated in the drawings. The inventive concept disclosed herein is capable of other embodiments or of being practiced or carried out in various ways. Also, it is to be understood that the phraseology and terminology employed herein is for the purpose of description and should not be regarded as limiting in any way.

In the following detailed description of embodiments of the disclosure, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

In one embodiment, the inventive concept disclosed herein is generally directed to a method and system for pitting users of similar skill level against one another in an on-line auction, such as a penny auction. This can be accomplished by ranking users in an online auction and scheduling auctions having rank ranges such that users having a rank identified by the rank range of an auction are presented with that auction, but users having a rank not identified by the rank range of an auction are not presented with that auction.

As used herein, the terms “network-based,” “cloud-based” and any variations thereof, are intended to cover the provision of configurable computational resources on demand via a network, with software and/or data at least partially located on the network, by pooling the processing power of a plurality of networked processors.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

In one exemplary embodiment, a system and method for ranking users of an online auction according to the inventive concept disclosed herein may group users into different ranks based on demographic criteria and/or skill at winning auctions. Such exemplary embodiment may employ a multiple regression analysis using demographic data. Users with different ranks may be presented with and/or allowed to participate in different auctions, based on their individual rank. On one hand, relatively inexperienced users may be presented with and/or allowed to participate in auctions from which relatively experienced users are excluded, in order to provide the relatively inexperienced users with more opportunities to win auctions, and thus encourage relatively inexperienced users to more likely become regular users on the auction site. On the other hand, in another example, more experienced users may be allowed to compete in an auction such that the auction is shortened and relatively inexperienced users are not driving the price of the item up.

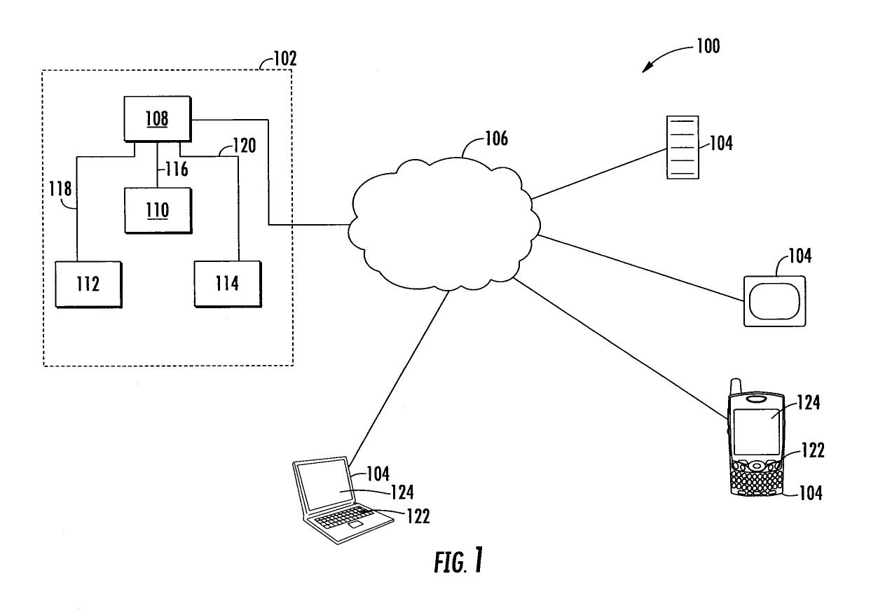

Referring now to FIG. 1, shown therein is an exemplary embodiment of an online auction system 100 according to the instant disclosure. The online auction system 100 comprises one or more host systems 102 capable of communicating with one or more user terminals 104 via a network 106.

The one or more host systems 102 comprise one or more processors 108 capable of executing processor executable code, one or more memoires 110 capable of storing processor executable code, an input device 112, and an output device 114, which can be partially or completely network-based or cloud-based, and not necessarily located in a single physical location.

The one or more processors 108 can be implemented as a single or multiple processors working together to execute the logic described herein. Exemplary embodiments of processor 108 include a digital signal processor (DSP), a central processing unit (CPU), a field programmable gate array (FPGA), a microprocessor, a multi-core processor, an application-specific integrated circuit, field programmable gate-array and combinations thereof. The one or more processor 108 is capable of communicating with the one or more memories 110 via a path 116 which can be implemented as a data bus for example. The one or more processor 108 is capable of communicating with the input device 112 and the output device 114 via paths 120a and 120b respectively. Paths 120a and 120b may be implemented similarly to or differently from path 116. The processor 108 is further capable of communicating with the one or more user terminals 104 via the network 106. It is to be understood that in certain embodiments using more than one processor 108, the processor 108 may be located remotely from one another, located in the same location, or comprising a unitary multi-core processor (not shown), for example.

The one or more memories 110 is capable of storing computer executable code and may be implemented as any conventional non-transitory memory 110, such as random access memory (RAM), a CD-ROM, a hard drive, a solid state drive, a flash drive, a memory card, a DVD-ROM, a floppy disk, an optical drive, and combinations thereof. It is to be understood that while memory 110 is shown located in the same physical location as the host system 102, memory 110 may be located remotely from the host system 102 and may communicate with the processor 108 via the network 106. Additionally, when more than one memory 110 is used, a memory 110a may be located in the same physical location as the host system 102, and a memory 110b may be located in a remote physical location from the host system 102. The physical location of memory 110 can be varied and may even be implemented as “cloud memory” i.e., memory 110 which is partially or completely based on, or accessed using, the network 106.

The input device 112 transmits data to the one or more processor 108, and can be implemented as a keyboard, a mouse, a touchscreen, a camera, a cellular phone, a tablet, a smart phone, a PDA, a microphone, a network adapter, and combinations thereof, for example. The input device 112 may be located in the same physical location as the host system 102, or may be remotely located and/or partially or completely network-based. The input device 112 communicates with the processor 108 via path 118.

The output device 114 transmits information from the one or more processor 108 to a user, such that the information can be perceived by the user. For example, the output device 114 can be implemented as a server, a computer monitor, a cell phone, a tablet, a speaker, a website, a PDA, a fax, a printer, a projector, a laptop monitor, and combinations thereof. The output device 114 can be physically co-located with the host system 102, or can be located remotely from the host system 102, and may be partially or completely network based (i.e., a website). The output device 114 communicates with the processor 108 via the path 120. As used herein the term “user” is not limited to a human, and may comprise a human, a computer, a host system, and combinations thereof, for example.

The network 106 permits bi-directional communication between the host system 102 and the user terminals 104. For example, the network 106 can be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof.

The one or more user terminals 104 can be implemented as a personal computer, a smart phone, network-capable TV set, TV set-top box, a tablet, an e-book reader, a laptop computer, a desktop computer, a network-capable handheld device, a video game console, a server, and combinations thereof, for example. Preferably, the user terminal 104 comprises an input device 122, an output device 124, and a web browser capable of accessing a website over a network.

The input device 122 is capable of receiving information input from a user, and transmitting such information input to the user terminal 104 and/or to the host system 102. The input device 122 can be any implemented as a keyboard, a touchscreen, a mouse, a trackball, a microphone, a fingerprint reader, an infrared port, a slide-out keyboard, a flip-out keyboard, a cell phone, a PDA, a video game controller, a remote control, a fax machine, and combinations thereof, for example.

The output device 124 outputs information in a form perceivable by a user. For example, the output device 124 can be a server, a computer monitor, a screen, a touchscreen, a speaker, a website, a TV set, a smart phone, a PDA, a cell phone, a fax machine, a printer, a laptop computer, and combinations thereof. It is to be understood that the input device 122 and the output device 124 may be implemented as a single device, such as for example a touchscreen or a tablet.

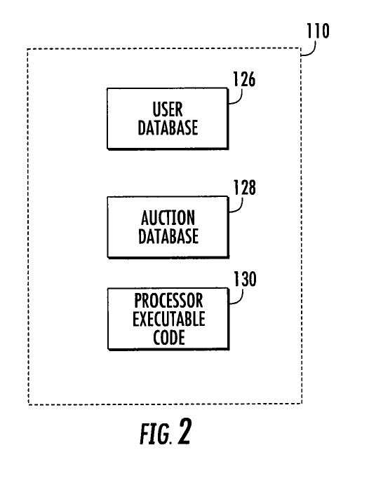

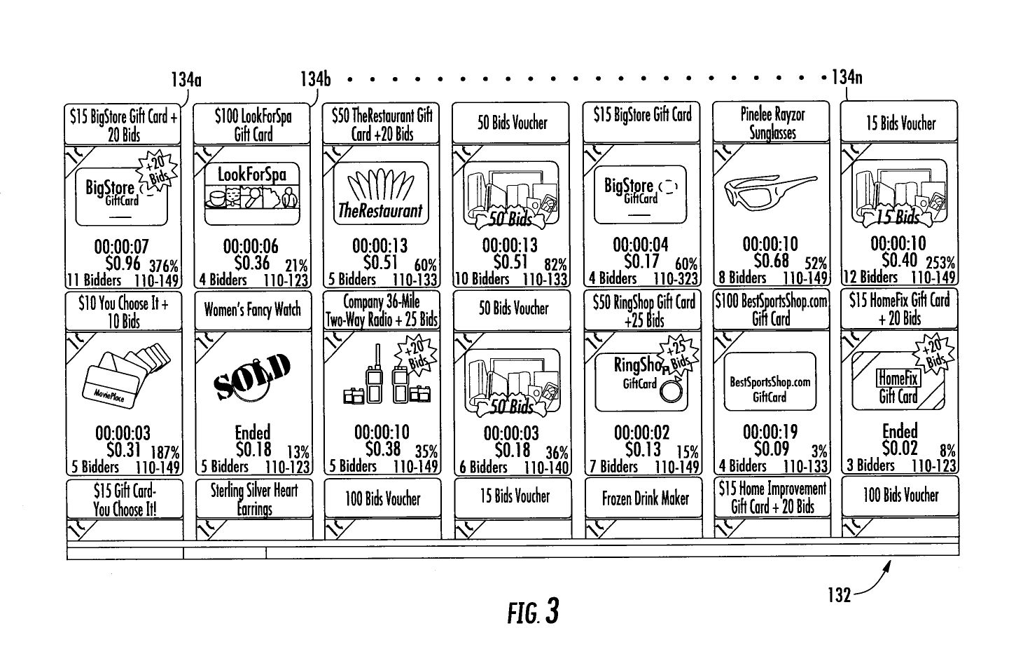

Referring now to FIG. 2, the memory 110 preferably stores information comprising a user database 126, an auction database 128, and processor executable code 130. The processor executable code 130 when executed by the one or more processor 108, preferably causes the one or more processor 108 to generate, maintain, and/or host a website providing two or more simultaneous auctions. The auctions will be described hereinafter as penny auctions, but can be other types of auctions. The processor executable code 130 causes the host system 102 to generate and serve a plurality of auction presentation pages 132 indicative of two or more online auctions 134a-n. The auctions 134a-n can include simultaneous auctions that are ongoing at a particular instant of time when the auction presentation pages 132 are generated and served. A sample screenshot of an exemplary embodiment of one of the auction presentation pages 132 is shown in FIG. 3. As can be seen in FIG. 3, the auction presentation page 132 shows a plurality of auctions 134a-n indicating a current price, the time remaining, and the item being auctioned. If a user presented with the auction presentation page 132 is interested, the user may select one or more of the auctions 134a-n and obtain more information and/or bid on the auctioned item. In a single instant of time (simultaneously, or within a relatively short period of time, e.g., 5 seconds), the processor executable code 130 can cause the processor 108 to present a first user with a first auction presentation page 132, which first auction presentation page 132 is not presented to a second user, for example, and a second user with a second auction presentation page 132 which is not presented to a first user. The first and second auction presentation pages 132 can be different and exclude the first user from participating in an auction 134a-n presented to the second user, and exclude the second user from participating in an auction 134a-n presented to the first user preferably based on ranks of the first and second user as discussed below. It is to be understood however that the first and the second auction presentation pages 132 may comprise the same or similar items being auctioned, such that the first and the second users are provided with a consistent consumer experience as they use the online auction system 100.

The auctions 134a-n shown in FIG. 3 are exemplary embodiments of penny auctions. In general, penny auction systems work as follows: the host system 102 presents one or more users with one or more auctions indicative of items for sale, each auction having a listed item price, beginning time, and end time. Users are charged a set amount for each bid placed, and may purchase pre-paid bid packages which are then used for bidding in a penny auction. Upon purchase, user accounts are credited with the number of bids within the bid packages. When the auction starts, a timer is set and begins to count down for a first time period. If the host system 102 receives a bid from a user before the end of the first time period, the received bid increases or changes the listed item price for the item that has been bid upon by a predetermined preset amount (which amount may be a negative number, zero, a positive number, and combinations thereof) and resets the timer to countdown for a second time period. The user account that submitted the bid is debited for the bid or cost of the bid. The host system 102 determines whether another bid has been received for the auctioned item within the second time period. If so, the process continues back around with the steps of receiving the bid, changing the auction listed item price, and resetting the timer until a bid is not received within the second time period. The process may also end when the auction is no longer open and there is no indication to purchase. It is noted that the host system 102 can be configured to provide a predetermined time window in which a user may purchase the auctioned item at a reduced value based upon bids submitted by the user (or full value if no bids were submitted by the user). This may be referred to as a “buy now” feature. For example, the user may be able to purchase the auctioned item during the auction only, or for up to 1 hour after the auction closes, or at any time after the auction closes. In this instance the item purchased is preferably not unique and/or multiple items are available for sale. The item may comprise a bid pack. Further, upon receipt of a bid, the listed item price may be increased a random amount, preferably within pre-defined limits.

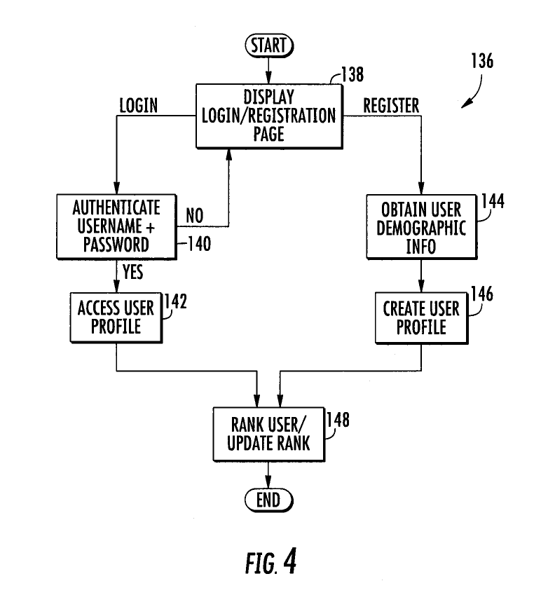

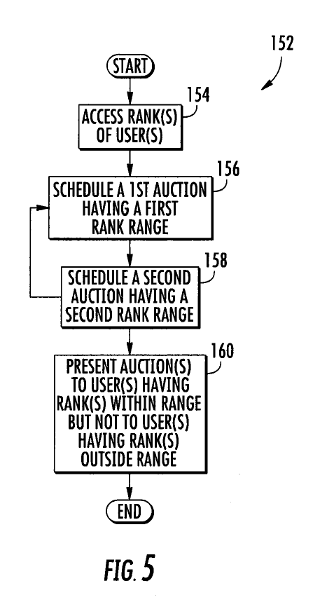

The processor executable code 130 further causes the processor 108 to execute a user ranking logic 136 (FIG. 4) and an auction scheduling logic 152 (FIG. 5).

Referring now to FIG. 4, shown therein is a logic flow diagram of an exemplary embodiment of a user ranking logic 136 according to the instant disclosure. The user ranking logic 136 comprises a step 138, where a user accessing the auction website of the host system 102 via the user terminal 104 is directed by the processor 108 to a login/registration page of the website.

If a user has previously registered with the host system 102, the user is prompted by the processor 108 to provide credentials (such as a username and password), which allow the processor 108 to authenticate the user against the user database 126 in a step 140. The host system 102 receives the credential and authenticates the user. The user database 126 preferably stores a user profile for each user. The user profile can include the following information: demographic information including name, age, address (e.g. geographic location of the user), billing information, username, password, behavioral information, experience, rank, gender, and the like, for example. If the user authentication is successful, the user's profile is accessed by the processor 108 in a step 142. If the user authentication fails, the user may be returned to the login/registration page of step 138 where the user may be prompted for a username and password again. Optionally, the processor 108 may block a user from entering a username and password after a preset number of failed authentication attempts.

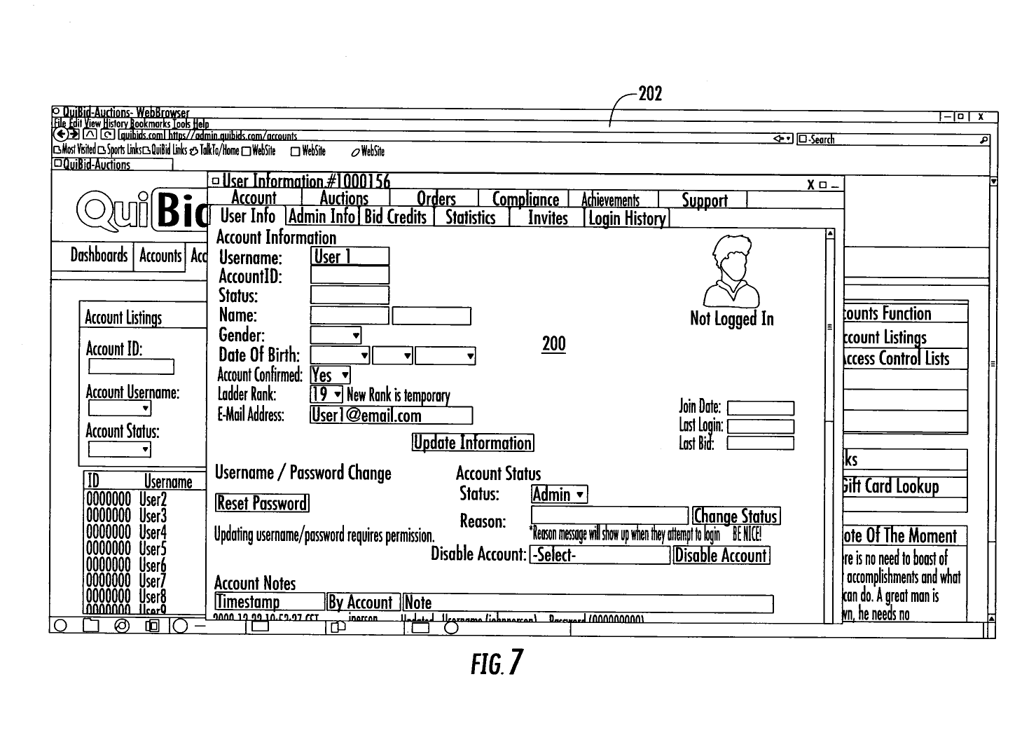

If the user has not registered before, demographic, billing, shipping, geographic information, desired username and password, and other information may be obtained from the user in a step 144. Next, a user profile is created in a step 146, and preferably stored in the user database 126 by the processor 108. The user profile may be stored and presented to a user in the form of a user account/registration page (FIG. 7).

After accessing the user profile in step 142 or creating a user profile in a step 146, the user ranking logic 136 causes the processor 108 to rank the user in a step 148. The ranking comprises accessing information from a user's profile which may be used to characterize the user within a population. For example, the ranking can utilize a user's demographic information (including but not limited to age, gender, geographic location, e-mail account provider, time of day that the user typically uses the site, occupation (or employment status), residence type and address, education level, billing address being the same as or different from the shipping address to determine whether the user is purchasing gifts, payment method, i.e., credit card, debit card, and/or third party payment service), technology parameter(s) such as user's operating system, type of and/or brand of hardware to access the site, type and/or version of browser, type and/or identification of internet service provider, communication methodology including cellular access, cable modem, dial-up, DSL, the user's experience (including but not limited to: initial bid pack purchased, past item wins, past bids, number of bids placed, number of auctions won, number of uses of buy now, number of wins within a preset period of time, total value of items won and/or purchased, as well as total amount spent on the site, time of bidding after purchase of bids, frequency of bidding, variety of items bid on, bidding on unique items, bidding strategy), and/or other user-specific or non-user-specific behavioral information/factors (e.g., how the user came to the site and behavior data from the online auction system 100 and/or from external sources), for example. A ranking algorithm may be executed by the processor 108 to rank the user. There are many suitable ranking algorithms that can be used. For example, the ranking of a new user may be based solely on the new user's demographic information since no user experience data or behavioral information/factors would be available. Alternatively, new users may be required to take a survey detailing their experience with online auctions, and the information obtained may be factored in by the ranking algorithm. It is to be understood that an administrator may manually assign a default rank to a new user, or the ranking system may automatically assign a default rank to a new user. Additionally, one or more users who have not logged in and/or registered may also be assigned a default rank and shown the set of auctions available for the default rank.

In an exemplary embodiment, the processor executable code 130 may cause the processor 108 to conduct a multiple regression analysis in order to rank users. The multiple regression analysis preferably causes the processor 108 to assign a rank between 0 and 49 to a user, with a rank of “0” indicating little or no experience (new user), and a rank of “49” indicating significant or extensive experience (experienced user). Alternatively, the user's rank may be manually assigned by an auction site administrator via the input device 112. A site administrator may use the input device 112 to assign a rank to a user, raise the current rank of a user, lower the current rank of a user, hold the rank of a user to a set level, and combinations thereof, for example.

It is to be understood that the choice of rank designations can be arbitrary and is not meant to limit the inventive concept discloses herein to only numerical ranks, or to only 50 ranks. Some non-limiting examples include ranks ranging from 1-N; A-Z; Novice-Slightly Experienced-Moderately Experienced-Highly Experienced-Expert-Master; Tin-Bronze-Silver-Gold-Platinum-Diamond; 1 star-N stars; level 1-level N, guppy-dolphin-whale-shark, and other methods of separating entities into categories based on a factor (e.g., experience, skill, age, gender, location, etc.). The rank may be a binary number stored in the memory 110 as a code, used to look up and/or correlate the user to a particular rank. For example, the code can be an address or used to look up a rank within a table.

In some exemplary embodiments, two or more users may be ranked with the same rank. In other embodiments, a preset number of users may be ranked with the same rank, which preset number of users can vary from 0 to N. Yet other embodiments may comprise multiple users having the same rank, a limited number of users having the same ranks, only one user assigned to a certain rank, and/or ranks not assigned to any users.

As an optional part of the ranking of users, the processor 108 may periodically update a user's rank. For example, a user's rank may be increased or decreased in response to the user winning an auction, losing an auction, bidding in an auction, utilizing a buy now feature (if available) at a list price, being a user for a predetermined amount of time, participating in a predetermined number of auctions, winning a certain dollar amount of items, achieving a preset number of wins within a preset period of time, aging, relocating, operating at a certain profit margin for the site owners, being presented with a certain number of auctions, and combinations thereof, for example. Such rank updates may be done periodically, in response to certain events, or in real-time, as will be understood by a person of ordinary skill in the art. As used herein, the term real-time is intended to mean that the period of time between event and system response is relatively short, as will be understood by a person of ordinary skill in the art.

It is to be understood that in embodiments of the online auction system 100 according to the instant disclosure implemented in the context of penny auctions, users may be ranked and/or presented with auctions only after purchasing one or more bids and/or bid packages.

Referring now to FIG. 5, shown therein is an exemplary embodiment of an auction scheduling logic 152 according to the instant disclosure. The auction scheduling logic 152 functions to generate and/or schedule the plurality of auctions 134a-n, assign to individual auctions from the plurality of auctions a first rank range for users to whom the auction will be presented, and present a set of auctions to a first user having a first rank within and/or identified by the predetermined first rank range.

In a step 154, the user database 126 is accessed by the processor 108, in order to access the ranks of a first user and a second user. Optionally, projected website traffic data may be accessed by the auction scheduling logic 152 at this step. The ranks of more than two users, a plurality of users, or a single user may be accessed in this step.

In a step 156, a first auction is scheduled and assigned a first rank range of users to be presented with the first auction. Next, in a step 158 a second auction is scheduled and assigned a second rank range of users to be presented with the second auction. In one embodiment, the first rank range may be different from the second rank range (i.e., the first rank range can be higher or lower than the second rank range). In another embodiment the first rank range and the second rank range may partially or completely overlap. Steps 156 and 158 may be repeated such that a plurality of auctions are scheduled as described above. The plurality of auctions scheduled preferably comprise a first set of auctions having the same first rank range to be presented to one or more first user(s) having a first rank in the first rank range, and a second set of auctions having the same second rank range to be presented to one or more second user(s) having a second rank within the second rank range.

In an exemplary embodiment the rank range may be implemented as a minimum rank and a maximum rank for users to be presented with an auction. Only users whose ranks is greater than or equal to the minimum rank, and lesser than, or equal to the maximum rank may be presented with the auction. The rank range may cover two rank levels, three rank levels, a plurality of rank levels, or one rank level, for example. Alternatively, a single rank may serve as a minimum and a maximum rank, and only a user or users having that rank may be presented with the auction. As used herein the terms “presented with an auction,” “presenting an auction,” “presented with the auction,” and other similar terms, and any variations thereof, are intended to include presenting an auction in a format perceivable by a user and/or allowing the user to participate in the auction by placing a bid for an auctioned item. The auction(s) may be presented to user(s) in a step 160, for example, by displaying an auction presentation page 132, by faxing the details of the auction, by announcing the auction over a speaker, by text messaging the auction information to a user terminal 104, by e-mailing the auction information to a user terminal 104, or the like.

Sets of scheduled auctions 134a-n may comprise varying numbers of auctions having varying item selections, and may be scheduled based on a variety of factors (usually correlated with time), such as projected user traffic patterns, behavioral data from users, auction participation patterns, geographic location of users, providing a consistent consumer experience for users, and combinations thereof, as will be apparent to a person of ordinary skill in the art presented with the instant disclosure. Sets of scheduled auctions 134 may include ongoing auctions, auctions scheduled to begin in the near future, and/or auctions that have recently ended. Such sets may be presented to a user in the form of the auction presentation page 132. Optionally, a first set of auctions having a first rank range may be presented to one or more first user(s) having a rank within the first rank range, but not presented to one or more second user(s) having a rank outside the first rank range. Alternatively, a first set of auctions having a first rank range may be presented to a first user having a first rank within or identified by the first rank range and to a second user having a second rank within or identified by the first rank range, but not to a third user having a third rank outside or not identified by the first rank range. In that way, the host system 102 may not be promoting auctions to additional potential users, but is rather restricting the number of potential users that are presented with an auction and/or allowed to participate in such auction. It is to be further understood that in an exemplary embodiment a first item selection in a first auction set having a first rank range may be identical to a second item selection in a second auction set having a second rank range. Further, in another exemplary embodiment the first item selections in the first auction set having a first rank range may be completely different from the second item selection in the second auction set having a second rank range, or the first item selection in the first auction set having a first rank range may overlap with the second item selection in the second auction set having a second rank range to a varying degree, such as partially overlapping, substantially overlapping, completely overlapping, and combination thereof, for example.

For example, the first item selection and the second item selection may overlap to a sufficient extent to allow a ranking system according to the instant disclosure to be substantially invisible, e.g. a first user having a first rank is presented with a first item selection and a second user having a second rank is presented with a second item selection which second item selection substantially (e.g. 80-90%) overlaps with the first item selection. For example, assuming a first user having a first rank is presented with a first item selection comprising a Sony Bravia TV set, a KitchenAid Blender, and an iPhone 4G, a second user having a second rank may be presented with a second item selection comprising a Sony Bravia TV set, a KitchenAid Blender, and an iPhone 4G. Further, the second user may be presented with a second item selection comprising a Sony Bravia TV set, a KitchenAid Blender, and an iPhone 3G. Alternatively, the second user may be presented with a second selection, comprising a Panasonic TV set, a Hamilton Beach blender, and a Nokia phone. As will be understood by persons of ordinary skill in the art, such arrangement of item selections in the sets of auctions may allow all users to bid on the same or similar item selection regardless of that particular user's rank, while at the same time allowing users having similar ranks to compete against one another and not against more experienced and/or higher-ranked users.

In an exemplary embodiment comprising a first user having a first rank lower than a second rank of a second user, the first user may be presented with a first auction set (with the auction presentation page 132, for example) having a first rank range comprising more auctions than a second auction set having a second rank range presented to the second user. The first rank is identified by, e.g., within the first rank range and the second rank is not identified by, e.g., outside the first rank range. At the same time, the second user may not be presented with the first auction set. It is to be understood that the first rank range and the second rank range may partially overlap, such that the first user is presented with one or more of the auctions in the second set of auctions, but the second user is presented with none of the auctions in the first set of auctions.

Rank ranges can be implemented as a code comprising one or more symbol(s)/data bit(s) such as 10-49. It should be understood that the rank range identified by the code can be the opposite or a different interpretation of the literal meaning of the code, for example a rank range of 10-49 may mean rank range 0-9. Further, the code can be correlated or linked to, a particular range of ranks. For example, a rank range could be identified by the letter “A” which is used to look up a range of 10-49 in a data table.

The auction scheduling logic 152 may schedule the auctions periodically, such as weekly, daily, hourly, in real-time, at an administrator's discretion, and combinations thereof, for example.

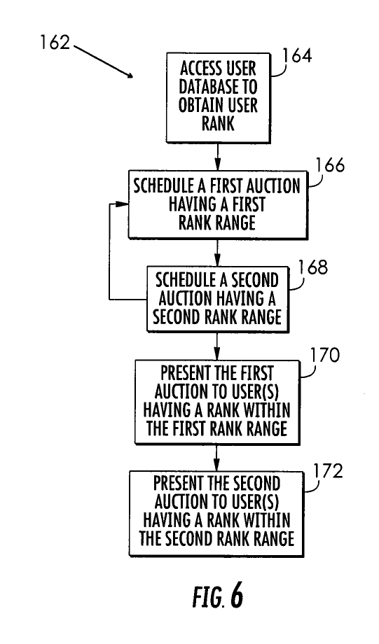

Referring now to FIG. 6, shown therein is an exemplary embodiment of a method 162 of scheduling auctions according to the instant disclosure. A step 164 of the method 162 comprises accessing a user database on a non-transitory computer medium by a processor, the user database comprising a first rank associated with a first user and a second rank associated with a second user. In a step 166 a first auction having a first rank range is scheduled by the processor. Next, in a step 168, a second auction having a second rank range is scheduled by the processor. Next, in a step 170, the first auction is presented to one or more user(s) having a rank identified by the first rank range by the processor. In a step 172, the second auction is presented to one or more user(s) having a rank identified by the second rank range by the processor.

Optionally, the scheduling steps 168 and 170 above may be repeated to schedule two or more auctions having a first rank range, the two or more auctions having the first rank range comprising a first set of auctions. The scheduling steps 168 and 170 may similarly schedule two or more auctions having a second rank range comprising a second set of auctions. In some embodiments, the first set of auctions may be presented to a first set of users having ranks within the first rank range, and the second set of auctions may be presented to one or more users having ranks in the second rank range, as will be appreciated by persons of ordinary skill in the art.

Referring now to FIG. 7 shown therein is screenshot of an exemplary embodiment of a user account/registration page 200 within a web browser 202 according to the instant disclosure. As can be seen, the user account/registration page 200 may have several fields for information associated with a user. Such fields may include a username selected by the user or assigned to the user by the host system 102. An Account ID may be assigned to the user's account by the host system 102 in order to keep track of the user's behavioral patterns and history on the auction website provided by the host system 102. The user's demographic information, includes but is not limited to name, gender, age (or date of birth in this case), address, e-mail, shipping information, and billing information (credit card type, number, and expiration date, PayPal® account, etc.). Some users may be assigned special status, such as administrator, user, etc. In the case of administrator-status users, options such as changing passwords and/or usernames of users, disabling user accounts, scheduling auctions, ranking users, and other administrative options may be shown in the user account/registration page.

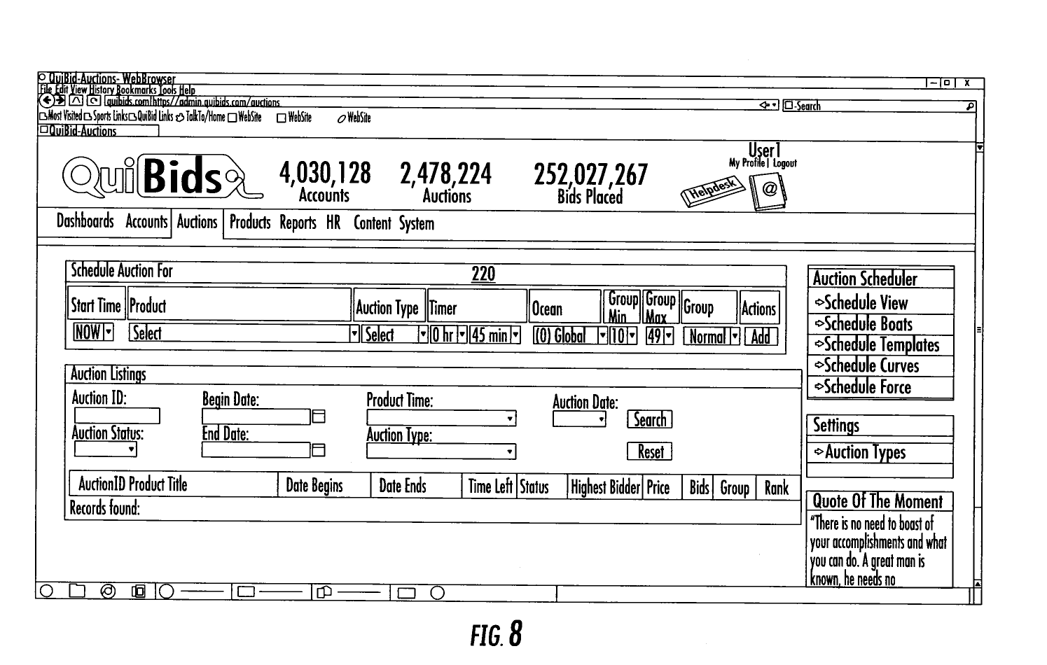

Referring now to FIG. 8, shown therein is a screenshot of an exemplary embodiment of an auction scheduling page 220 according to the instant disclosure. As shown in FIG. 8, an auction can be scheduled to start immediately, or in some future time. A product to be auctioned can be selected, and several types of auctions may be used, such as buy now, blitz, or the like. The auction timer indicates the time after which the auction is scheduled to end. The ocean box allows for selecting one of several available local markets to present an auction in. The local markets can be country-wide, city-wide, state-wide, continent-wide, region-wide, and the like, for example. The fields “Group Min” and “Group Max” receive information indicative of the rank range for users to whom the auction will be presented. The “Group Min” field receives a code indicative of a first and/or a lower boundary for the rank range, and the “Group Max” field receives a code indicative of a second and/or upper boundary of the rank range. Once all the fields have been populated, the auction is added to the website, and an auction web page indicative of the auction is created and presented to users having ranks within the rank range indicated in the “Group Min” and “Group Max.” Alternatively, the rank range may not have a lower boundary and may be used by the host system 102 to restrict the auction from being presented to users having a rank above the rank range. For example, assuming that the host system 102 supports ranks between 0-49, and a rank range of 40 is selected for an auction, the auction would be presented to users having ranks between 0-40 and not presented (or hidden from) users having ranks between 41-49. In other words, the host system 102 will restrict the auction from being presented to users having ranks from 41-49.

From the above description, it is clear that the inventive concept(s) disclosed herein is well adapted to carry out the objects and to attain the advantages mentioned herein as well as those inherent in the inventive concept(s) disclosed herein. While presently preferred embodiments of the inventive concept(s) disclosed herein have been described for purposes of this disclosure, it will be understood that numerous changes may be made which will readily suggest themselves to those skilled in the art and which are accomplished within the scope and spirit of the inventive concept(s) disclosed herein and defined by the appended claims.

What is claimed is:

1. An online auction system comprising:
a host system comprising at least one processor capable of executing processor executable code; at least one non-transient memory capable of communicating with the at least one processor and storing processor executable code comprising a first rank associated with a first user and a second rank associated with a second user;
wherein the processor executable code when executed by the at least one processor, causes the at least one processor to:
access the first rank and second rank;
schedule a first auction having a first rank range and a second auction having a second rank range; and
present the first auction having the first rank range to the first user and the second auction having the second rank range to the second user;
wherein the first rank of the first user falls within the first rank range and the second rank of the second user falls within the second rank range.

2. The online auction system of claim 1, wherein the at least one processor schedules a first set of auctions having a first rank range and a second set of auctions having a second rank range and presents the first set of auctions to the first user and the second set of auctions to the second user.

3. The online auction system of claim 1, wherein the at least one processor schedules a first set of auctions having a first rank range and a first item selections and a second set of auctions having a second rank range and a second item selections, and presents the first set of auctions to the first user and the second set of auctions to the second user.

4. The online auction system of claim 3, wherein the first item selections include at least 85% of the same items as the second item selections.

5. The online auction system of claim 1 wherein the first auction is for a first item, and the second auction is for a second item, and wherein the first item and the second item are the same type of item.

6. A method for scheduling online auctions, comprising:
accessing, by a host system comprising at least one processor, processor executable code stored on a non-transient memory, the processor executable code comprising a first rank associated with a first user and a second rank associated with a second user;
scheduling, by the at least one processor, a first auction having a first rank range and a second auction having a second rank range;
presenting the first auction having the first rank range to the first user and the second auction having the second rank range to the second user; and
wherein the first rank of the first user is identified by the first rank range and the second rank of the second user is identified by the second rank range.

7. An online auction system comprising:
a host system comprising at least one processor capable of executing processor executable code; at least one non-transient memory capable of communicating with the at least one processor and storing processor executable code comprising a first rank associated with a first user and a second rank associated with a second user;
wherein the processor executable code when executed by the at least one processor, causes the at least one processor to:
access the first rank and the second rank;
schedule a first auction having a first rank range; and
present the first auction having the first rank range to the first user but not to the second user;
wherein the first rank of the first user is identified by the first rank range and the second rank of the second user is not identified by the first rank range.

8. The online auction system of claim 7, wherein the at least one processor schedules a first set of auctions having a first rank range and presents the first set of auctions to the first user but not to the second user.

9. The online auction system of claim 7, wherein the at least one processor schedules a first set of auctions having a first rank range and a first item selection and a second set of auctions having a second rank range and a second item selection, and presents the first set of auctions to the first user and the second set of auctions to the second user.

10. The online auction system of claim 7, wherein the first item selection is substantially identical with the second item selection.

11. An online auction system comprising:
a host system comprising at least one processor capable of executing processor executable code; and at least one non-transient memory capable of communicating with the at least one processor and storing processor executable code comprising a first rank associated with a first user and a second rank associated with a second user;
wherein the processor executable code when executed by the at least one processor, causes the at least one processor to execute auction presentation logic to:
(a) receive information indicative of a first item to be auctioned, including a rank range;
(b) analyze a first user profile of a first user logged into the host system with the rank range;
(c) analyze a second user profile of a second user logged into the host system with the rank range;
(d) generate one or more first auction presentation pages for the first user including the first item based upon the analysis of the first user profile; and
(e) generate one or more second auction presentation page for the second user not including the first item based upon the analysis of the second user profile.

12. The online auction system of claim 11, wherein steps (b)-(e) occur at a single instant of time.

13. The online auction system of claim 11, wherein the one or more first and second auction presentation pages further include information indicative of a plurality of auctions.

14. The online auction system of claim 13, wherein the one or more first auction presentation pages include all auctions available for the first user at a particular instant in time.

15. A method, comprising the steps of:
receiving, by a host system configured to provide an auction, a logon command from a terminal for a particular user having a rank;
serving one or more auction presentation pages to the terminal including ongoing or upcoming auctions that match the rank of the user.

16. A method, comprising the steps of:
receiving a logon command by a host system from a terminal for a user having a rank, the host system configured to provide multiple simultaneous auctions including first auctions matching the rank of the user and second auctions not matching the rank of the user; and
serving one or more auction presentation pages to the terminal with the first auctions and without the second auctions.

17. A method, comprising the steps of:
crediting an account of a user with a first bid and a second bid;
receiving a logon command by a host system from a terminal for a user having a rank, the host system configured to provide multiple simultaneous auctions including first auctions matching the rank of the user and second auctions not matching the rank of the user;
serving one or more auction presentation pages to the terminal with the first auctions and without the second auctions; and
receiving the first bid from the user for a first item of one of the first auctions; and
increasing a price of the first item by a predetermined amount responsive to receiving the first bid.

18. A method, comprising the steps of:
crediting an account of a user with a first bid;
logging the user into the account by a host system, the account having a rank of the user, the host system configured to provide multiple simultaneous auctions including first auctions matching the rank of the user and second auctions not matching the rank of the user;
serving one or more auction presentation pages to the user with the first auctions and without the second auctions, while the user is logged on;
receiving the first bid from the user for a first item before a first ending time of one of the first auctions;
increasing a price of the first item by a predetermined amount responsive to receiving the first bid; and
extending the first ending time of the one of the first auctions by an amount of time defining a second ending time of the one of the first auctions.

19. The method of claim 18, further comprising the step of crediting the account of the user with a second bid.

20. The method of claim 18, wherein no bids are received before the second ending time, and further comprising the step of awarding the first item to the user.

21. An online auction system comprising:
a host system comprising at least one processor capable of executing processor executable code; and at least one non-transient memory capable of communicating with the at least one processor and storing processor executable code;
wherein the processor executable code when executed by the at least one processor, causes the at least one processor to:
credit an account of a user with a first bid;
log the user into the account by a host system, the account having a rank of the user, the host system configured to provide multiple simultaneous auctions including first auctions matching the rank of the user and second auctions not matching the rank of the user;
serve one or more auction presentation pages to the user with the first auctions and without the second auctions, while the user is logged on;
receive the first bid from the user for a first item before a first ending time of one of the first auctions;
change a price of the first item by a predetermined amount responsive to receiving the first bid; and
extend the first ending time of the one of the first auctions by an amount of time defining a second ending time of the one of the first auctions.

22. The online auction system of claim 21, wherein the processor executable code when executed by the at least one processor causes the at least one processor to credit the account of the user with a second bid.

23. An online auction system comprising:
a host system comprising at least one processor capable of executing processor executable code; and at least one non-transient memory capable of communicating with the at least one processor and storing processor executable code comprising a first rank associated with a first user and a second rank associated with a second user;
wherein the processor executable code when executed by the at least one processor, causes the at least one processor to execute auction presentation logic to:
(a) receive information indicative of two or more first items to be auctioned;
(b) analyze a first user profile of a first user logged into the host system with a first rank range;
(c) analyze a second user profile of a second user logged into the host system with a second rank range;
(d) generate one or more first auction presentation pages for the first user including at least one of the two or more first items based upon the analysis of the first user profile; and
(e) generate one or more second auction presentation page for the second user including at least one of the two or more first items based upon the analysis of the second user profile.

24. The online auction system of claim 23, wherein steps (b)-(e) occur at a single instant of time.

25. The online auction system of claim 23, wherein the one or more first and second auction presentation pages further include information indicative of a plurality of auctions.

26. The online auction system of claim 23, wherein the one or more first auction presentation pages include all auctions available for the first user at a particular instant in time.
